(19) United States
(12) Patent Application Publication
(10) Pub. No.: US 2010/0116548 A1
(43) Pub. Date: May 13, 2010

(54) INSULATED WIRE AND A WIRING HARNESS

(75) Inventor: Tsuyoshi Nonaka, Yokkaichi-shi (JP)

Correspondence Address: OLIFF & BERRIDGE, PLC, P.O. BOX 320850, ALEXANDRIA, VA, 22320-4850, US

(73) Assignees: AUTONETWORKS TECHNOLOGIES, LTD., Yokkaichi-shi, (JP); SUMITOMO WIRING SYSTEMS, LTD., Yokkaichi-shi, (JP); SUMITOMO ELECTRIC INDUSTRIES, LTD., Osaka-shi, (JP)

(21) Appl. No.: 12/450,805

(22) PCT Filed: Apr. 25, 2008
(86) PCT No.: PCT/JP2008/058057

§ 371 Date: Oct. 14, 2009

(30) Foreign Application Priority Data
Apr. 27, 2007 (JP) 2007-119685

(51) Int. Cl. H02G 3/04; H01B 7/295

(52) U.S. Cl. 174/72 A; 174/110 SR

(57) ABSTRACT

An insulated wire and a wiring harness possessing sufficient flame retardancy and wear resistance superior to a conventional insulated wire.

An insulated wire includes a conductor, and an insulator made up of multiple layers which covers the conductor, wherein the outermost layer is made from a resin composition containing a flame retardant, and the innermost layer is made from a resin composition containing a smaller flame retardant than in the outermost layer or no flame retardant. The outermost and innermost layers preferably contain respectively 30-250 parts by mass of the flame retardant and 5-50 parts by mass of the flame retardant to 100 parts by mass of the respective resin ingredients. The innermost layer has a thickness preferably ½ or less than the insulator, while the insulator has a thickness of preferably 0.5 mm or less. A wiring harness includes the insulated wire.

### TECHNICAL FIELD

The present invention relates to an insulated wire and a wiring harness, and more specifically relates to an insulated wire and a wiring harness favorably used for vehicle parts and parts for an electrical/electronic appliance.

### BACKGROUND ART

Conventionally, for an insulated wire used in carrying out wiring of vehicle parts for an automobile and parts for an electrical/electronic appliance, there is widespread use of an insulated wire in which a vinyl chloride resin composition which is prepared by adding a halogenous flame retardant thereto covers a conductor.

However, there is a problem that this kind of vinyl chloride resin composition contains halogen elements, so that it emits harmful halogenous gas into the atmosphere in case of car fire or at the time of combustion for disposing of the electrical/electronic appliance by incineration, causing environmental pollution.

Therefore, from the viewpoint of reducing loads on the global environment, the vinyl chloride resin composition has been recently replaced with a so-called non-halogenous flame-retardant resin composition, which is prepared by adding metal hydroxide such as magnesium hydroxide as a non-halogenous flame retardant to an olefin resin such as polyethylene.

For example, Japanese Patent Gazette No. 3339154 discloses an insulated wire which is covered with a flame-retardant composition prepared by adding magnesium hydroxide as a flame retardant to a resin such as an ethylene-ethylacrylate copolymer (EEA) and polyethylene, or a rubber such as an ethylene-propylene rubber.

### DISCLOSURE OF THE INVENTION

### Problems to be Solved by the Invention

However, the olefin resin is essentially combustible, and the non-halogenous flame retardant is inferior to a halogenous flame retardant in effect of flame retardancy. For these reasons, the non-halogenous flame-retardant resin composition requires a large amount of metal hydroxide to be added thereto in order to secure sufficient flame retardancy. Thus, a disadvantage that mechanical properties such as wear resistance remarkably degrade has been brought to a conventional insulated wire.

An object of the present invention is to overcome the problems described above and to provide an insulated wire which possesses sufficient flame retardancy and shows wear resistance superior to the conventional insulated wire. In addition, an object of the present invention is to provide a wiring harness including the insulated wire.

### Means to Solve the Problem

As a result of keen examination by the inventor of the present invention, he succeeded in making findings that wear resistance can be improved while sufficient flame retardancy is maintained, by developing a blending ratio of flame retardants in layers of an insulator and obtaining improved adherence between a conductor and the insulator and accordingly completed the present invention.

That is, the insulated wire according to a preferred embodiment of the present invention includes a conductor, and an insulator made up of multiple layers which covers the conductor, wherein the outermost layer of the insulator is made from a resin composition containing a flame retardant, and the innermost layer of the insulator is made from a resin composition which contains a smaller amount of a flame retardant than in the resin composition of the outermost layer or contains no flame retardant.

It is preferable that the outermost layer contains 30 to 250 parts by mass of the flame retardant with respect to 100 parts by mass of a resin ingredient in the outermost layer.

It is also preferable that the innermost layer contains 5 to 50 parts by mass of the flame retardant with respect to 100 parts by mass of a resin ingredient in the innermost layer.

It is also preferable that the innermost layer has a thickness ½ or less than that of the insulator.

It is also preferable that the insulator has a thickness of 0.5 mm or less.

A wiring harness according to a preferred embodiment of the present invention includes the insulated wire according to the present invention.

### EFFECTS OF THE INVENTION

Since the insulated wire according to the preferred embodiment of the present invention includes the conductor and the insulator made up of multiple layers which covers the conductor wherein the innermost layer of the insulator is made from the resin composition which contains the smaller amount of the flame retardant than in the resin composition of the outermost layer or contains no flame retardant, the insulated wire according to the preferred embodiment of the present invention shows improved adherence between the conductor and the insulator and excellent wear resistance compared with a conventional insulated wire which is covered with an insulator made up of a single layer which contains a large amount of a flame retardant, for example. In addition, since the outermost layer of the insulator is made from the resin composition containing the flame retardant, the outermost layer retains sufficient flame retardancy.

If the outermost layer contains 30 to 250 parts by mass of the flame retardant with respect to 100 parts by mass of the resin ingredient in the outermost layer, the insulated wire shows excellent flame retardancy.

If the innermost layer contains 5 to 50 parts by mass of the flame retardant with respect to 100 parts by mass of the resin ingredient in the innermost layer, the conductor and the insulator have excellent adherence therebetween and the innermost layer shows improved flame retardancy.

In addition, if the innermost layer has the thickness ½ or less than that of the insulator, the insulated wire shows excellent flame retardancy.

Further, if the insulator has the thickness of 0.5 mm or less, the insulated wire can be used as a small-diameter electric wire.

Meanwhile, the wiring harness according to the preferred embodiment of the present invention includes the insulated wire described above, so that the wiring harness retains sufficient flame retardancy and shows excellent wear resistance. In addition, the wiring harness can ensure high reliability over a long period of time when used since the insulated wire possesses wear resistance.

### BEST MODE FOR CARRYING OUT THE INVENTION

A detailed description of preferred embodiments of the present invention will now be provided.

An insulated wire according to the preferred embodiment of the present invention includes a conductor, and an insulator made up of multiple layers which covers the conductor. The number of the layers of the insulator is not limited in particular, and it is essential only that the number should be two or more. In general, because if the layers increase in number, a manufacturing process becomes complicated, the number of the layers is preferably two or three in view of manufacturability.

If the insulated wire is used in an automobile, the thickness of the insulator is, though not limited in particular, preferably 0.5 mm or less considering that the insulated wire can be used as a small-diameter automobile electric wire. This is because automobile electric wires have been reduced in weight and diameter recently.

The outermost layer of the insulator is made from a resin composition containing a flame retardant, and the innermost layer of the insulator is made from a resin composition which contains a smaller amount of a flame retardant than in the resin composition of the outermost layer or contains no flame retardant.

When the insulator is made up of two layers, the layers define the outermost layer and the innermost layer. When the insulator is made up of three or more layers, the layers define the outermost layer, the innermost layer, and one or more than one middle layer sandwiched therebetween. In this case, the middle layer may be made from a resin composition containing a flame retardant or a resin composition containing no flame retardant. When the middle layer contains a flame retardant, the amount thereof may be larger or smaller than in the outermost layer, and may be larger or smaller than in the innermost layer if the innermost layer contains a flame retardant.

For example, in the insulator, a blending ratio of the flame retardants in the layers is arranged such that the inner layer contains a smaller amount of the flame retardant while the outermost layer contains the largest amount of the flame retardant (a gradual blend), such that the outermost layer contains the flame retardant while the layers inner than the outermost layer contain no flame retardant, or the layers outer than the innermost layer contain the flame retardants while the innermost layer contains no flame retardant. In these cases, it is preferable that the amount of the flame retardant contained in the outermost layer is sufficient enough to contribute to flame retardancy.

In view of flame retardancy, the outermost layer preferably contains 30 parts by mass or more of the flame retardant, and more preferably 50 parts by mass or more of the flame retardant, and still more preferably 60 parts by mass or more of the flame retardant with respect to 100 parts by mass of a resin ingredient in the outermost layer. Meanwhile, in order to obtain sufficient mechanical properties, the outermost layer preferably contains 250 parts by mass or less of the flame retardant, and more preferably 200 parts by mass or less of the flame retardant, and still more preferably 180 parts by mass or less of the flame retardant with respect to 100 parts by mass of the resin ingredient in the outermost layer.

The thickness of the outermost layer is preferably large enough to possess flame retardancy though it is not limited in particular. For example, the thickness of the outermost layer may be adjusted appropriately in relation to the amount of the flame retardant contained in the outermost layer. When the insulated wire has a middle layer, the thickness of the outermost layer may be adjusted appropriately in relation to the amount of the flame retardant contained in the middle layer and the thickness of the middle layer. The thickness of the outermost layer is preferably within a range of 0.05 to 0.4 mm, and more preferably within a range of 0.1 to 0.2 mm.

The innermost layer is in contact with the conductor and contributes to adherence between the insulator and the conductor. When the amount of the flame retardant contained in the innermost layer is small, the innermost layer shows improved adherence to the conductor. Accordingly, it is preferable that the innermost layer contains no flame retardant, or a small amount of the flame retardant, if any. The small amount in this regard defines an amount smaller than that of the flame retardant in the outermost layer.

When the innermost layer contains the flame retardant, it preferably contains 5 to 50 parts by mass of the flame retardant with respect to 100 parts by mass of a resin ingredient in the innermost layer. If the innermost layer contains the flame retardant within this range, the insulator and the conductor have excellent adherence therebetween. In addition, if the insulator and the conductor have excellent adherence therebetween, the insulator shows improved cold resistance.

Cold resistance of the insulator is affected also by an elongation characteristic of its material at a low temperature. In general, an elongation characteristic of a material at a low temperature is easily degraded when a large amount of a filler such as a flame retardant is added to the material, while not easily degraded when a small amount of a filler is added to the material. Therefore, if the innermost layer contains the small amount of the flame retardant, the elongation characteristic of the material at a low temperature is not degraded, leading to contribution to improved cold resistance of the insulator also in a material aspect.

As described above, it is preferable that the amount of the flame retardant contained in the innermost layer is small in order to secure adherence between the insulator and the conductor. However, if the amount of the flame retardant contained in the innermost layer is small, the innermost layer shows low flame retardancy. In this case, if the innermost layer which has low flame retardancy takes a large part of the insulator, the insulator shows low flame retardancy. Therefore, the thickness of the innermost layer which has low flame retardancy is preferably ½ or less of the thickness of the insulator in view of securing flame retardancy.

Examples of the resin ingredients from which the outermost layer, the innermost layer, and the middle layer of the insulator are made include alpha-olefin such as ethylene, propylene, 1-butene, 1-hexene, 1-octane, and 4-methyl-1-pentene, which is used in the form of a homopolymer, or a copolymer, or in the form of a mixture thereof.

The material from which the insulator is made may contain a thermoplastic elastomer. If the thermoplastic elastomer is contained in the material, a tendency to improve flexibility and workability is shown. For the thermoplastic elastomer, a styrene type thermoplastic elastomer or an ethylene type thermoplastic elastomer can be used. They may be used by one sort alone, or more than one sort in combination.

Examples of the styrene type thermoplastic elastomer include a styrene-ethylene-butylene-styrene block copolymer (SEBS), a styrene-ethylene-propylene-styrene block copolymer (SEPS), a styrene-ethylene-propylene block copolymer (SEP), a styrene-ethylene-ethylene-propylene-styrene block copolymer (SEEPS).

Examples of the ethylene type thermoplastic elastomer include a copolymer of ethylene and propylene, 1-butene, 1-penten and/or 1-hexene.

The elastomer may be modified by acid. To apply acid to the elastomer, a grafting method or a direct (copolymerization) method is preferably used. For the acid, an unsaturated carboxylic acid or a derivative thereof is preferably used. To be more specific, examples of the unsaturated carboxylic acid include a maleic acid and a fumaric acid, and examples of the derivative include a maleic acid anhydride (MAH), a maleic acid monoester and a maleic acid diester. They may be used by one sort alone, or more than one sort in combination. In particular, the maleic acid and the maleic acid anhydride are preferably used.

For the flame retardants to be added to the insulator material, a non-halogenous flame retardant is preferably used. In particular, metal hydroxide is preferably used. Examples of the metal hydroxide include magnesium hydroxide, aluminum hydroxide and calcium hydroxide. In particular, the magnesium hydroxide is preferably used. For the magnesium hydroxide, so-called synthesized magnesium hydroxide or natural magnesium hydroxide prepared by pulverizing a natural mineral may be used.

The average particle size of the metal hydroxide is preferably within a range of 0.1 to 20 μm, more preferably within a range of 0.2 to 10 μm, and still more preferably within a range of 0.5 to 5 μm. If the average particle size is less than 0.1 μm, secondary cohesion of particles tends to occur which easily degrades the mechanical properties of the wire. On the other hand, if the average particle size is more than 20 μm, the appearance of the shape of the wire tends to be unfavorable.

The metal hydroxide may be subjected to a surface treatment with a treatment agent. Examples of the treatment agent include a silane coupling agent (e.g., vinylsilane, acrylsilane), a titanate coupling agent, a higher fatty acid (e.g., a stearic acid, an oleic acid), a higher fatty acid ester, a metal salt of a higher fatty acid, and an olefin wax. They may be used by one sort alone, or more than one sort in combination. The metal hydroxide which is surface-treated with the treatment agent shows improved adherence to the resin ingredients.

The treatment agent is preferably used within a range of 0.1 to 10 parts by mass, and more preferably used within a range of 0.1 to 5 parts by mass with respect to 100 parts by mass of the metal hydroxide. If less than 0.1 part by mass of the treatment agent is used, a tendency to easily degrade an improvement effect in a wire property is shown, while if more than 10 parts by mass of the treatment agent is used, an excess of the thus-added treatment agent tends to remain as an impurity, so that a tendency to degrade a physical property of the wire is shown.

The metal hydroxide may be previously surface-treated with the treatment agent, or the metal hydroxide may be blended into the resin compositions from which the insulator is made, together with the treatment agent, and be surface-treated by kneading the resin compositions.

Other additives may be blended as necessary into the insulator material within the range of not impairing the properties of the insulator material. The additives are not limited in particular, and a filler commonly used for a wire covering material, a pigment, an oxidation inhibitor, an age inhibitor and/or a copper inhibitor may be used, for example.

The outermost layer, the innermost layer, and the middle layer may be made from a same resin ingredient or different resin ingredients. In view of manufacturability, it is preferable that the layers are made from materials having no difference (or having a small difference) in fluidity. This is because, in view of manufacturability, the conductor is preferably extrusion-covered simultaneously with the layer materials, and accordingly, it is preferable that the layer materials have no difference in fluidity in the extrusion covering.

For the conductor, a single metal wire, a strand of a plurality of metal wires, and a strand on which compression is applied are preferably used. The diameter of the conductor is not limited in particular and may be chosen appropriately according to the intended use.

Next, a description of a production process of the wire according to the preferred embodiment of the present invention will be provided. The production process of the present wire is not limited in particular, and a publicly known production process can be used.

For an example of the production process, the resin compositions from which the insulator is made are first prepared. To be specific, if the insulator is made up of two layers of the outermost and innermost layers, the resin compositions are prepared respectively for the outermost and innermost layers. For example, each resin composition is prepared by blending the resin, the elastomer, the metal hydroxide, and the other ingredients and additives as appropriate, and dry-blending them with the use of a regular tumbler, or melting and kneading them to be dispersed uniformly with the use of a regular kneader such as a Banbury mixer, a pressure kneader, a kneading extruder, a twin-screw extruder and a roll.

Next, the conductor is covered with the thus-prepared resin compositions in given thicknesses with the use of an extrusion molding machine or other machines. At this time, the conductor may be extrusion-covered first with the resin composition from which the innermost layer is made, and then with the resin composition from which the outermost layer is made. Alternatively, the conductor may be extrusion-covered simultaneously with the resin compositions from which the innermost and the outermost layers are made. In view of manufacturability, the simultaneous extrusion-covering is preferable.

When the insulator is made up of three or more layers, each resin composition from which the insulator is made can be prepared in the same manner as described above and extruded sequentially or simultaneously in the same manner as described above.

Next, a description of a wiring harness according to the preferred embodiment of the present invention will be provided.

The wiring harness according to the preferred embodiment of the present invention is prepared by covering a wire bundle which is made up only of a plurality of the present insulated wires or made up of the present insulated wires and other electric wires in combination, with a wiring-harness protective material. For the electric wires other than the present insulated wires, an electric wire containing a halogen element (e.g., a vinyl chloride wire) and an electric wire containing no halogen element may be used. The number of the wires is not limited in particular and can be determined arbitrary.

The wiring-harness protective material is used for covering the wire bundle made up of the plurality of the insulated wires and protecting the thus-covered wire bundle from an external environment. Although a base material from which the wiring-harness protective material is made is not limited in particular, and a polyolefin type resin composition such as polyethylene, and polypropylene is preferably used. It is preferable that a flame retardant such as a metal hydroxide is appropriately added to the resin composition.

As the wiring-harness protective material, a wiring-harness protective material having a tape-shaped base material at least one side of which an adhesive is applied on, or a wiring-harness protective material having a base material which is tube-shaped or sheet-shaped for example may be selected according to the intended use.

### Example

A description of the preferred embodiments of the present invention will now be provided specifically with reference to examples though the present invention is not limited hereto.

Test Material, Manufacturer, and Other Factors

Test materials used in the present examples are given along with manufacturers, trade names, values of physical properties and other factors.

Materials for Insulator

Polypropylene [manuf.: Japan Polypropylene Corporation, trade name: “NOVATEC-PP EC7”];

Polyethylene [manuf.: Nippon Unicar Company Limited, trade name: “NUC 8008”]; and

Magnesium hydroxide [manuf.: Martinswerk GmbH, trade name: “MAGNIFIN H10”, average particle size: 1.0 μm].

Preparation of Compositions for Outermost Layer and Innermost Layer

Firstly, compositions for outermost layers and compositions for innermost layers of insulated wires according to the pre sent examples and comparative examples were prepared by kneading the ingredients shown in Table 1 to be described below at a temperature of 200° C. using a twin-screw kneader and pelletizing them using a pelletizing machine. Example 6 further includes a middle layer. For materials from which the middle layer is made, 100 parts by mass of polypropylene and 100 parts by mass of magnesium hydroxide were used.

Preparation of Insulated Wire

Insulated wires according to the examples and comparative examples were each prepared by extrusion-covering a conductor (a cross sectional area: 0.5 mm²) which is a soft-copper strand made up of seven soft copper wires with the compositions for the layers to have the thicknesses shown in Table 1 using an extruder (the thickness of each insulator was arranged to be 0.2 mm).

The insulated wires prepared as above were each subjected to a flame-retardancy test, a wear-resistance test, and a cold-resistance test. Hereinafter, descriptions of the respective procedures of the tests will be provided.

Flame-Retardancy Test

The flame-retardancy test was performed based on JASO D611-94. To be more specific, each of the insulated wires was cut into a test specimen 300 mm long. Then, each of the test specimens was placed in an iron test box to be held horizontal, and the tip of a reducing flame by a Bunsen burner having a caliber of 10 mm was placed beneath the center of each of the test specimens within 30 seconds until the test specimens are burned, and then, after the flame was calmly removed, an afterflame time of each of the test specimens was measured. The test specimen whose afterflame time was within 15 seconds was regarded as passed, and the test specimen whose afterflame time was over 15 seconds was regarded as failed.

Wear-Resistance Test

The wear-resistance test was performed by a blade-reciprocating method based on JASO D611-94. To be more specific, each of the insulated wires was cut into a test specimen 750 mm long. Then, at room temperatures of 23±5° C., a blade was made to reciprocate in a direction of its shaft over a length of 10 mm or more on surfaces of the insulators of the test specimens which were fixed to a table, and the numbers of reciprocation before the blade touches the conductors due to the wearing out of the insulators were counted. A load imposed on the blade was set at 7N, and the blade was made to reciprocate at a speed of 50 times/minute. Then, the test specimens were moved by 100 mm and rotated 90 degrees clockwise, and the measurement as described above was repeated. The measurement was performed three times in total with respect to one test specimen, and the test specimen whose smallest reciprocation number was 200 or more was regarded as passed, and the test specimen whose smallest reciprocation number was below 200 was regarded as failed.

Cold-Resistance Test

The cold-resistance test was performed based on JIS C3005. To be more specific, each of the prepared insulated wires was cut into five test specimens, each 38 mm long. The five test specimens for each of the present examples and comparative examples were set in a test machine and were hit with a striking implement while being cooled, and the temperature at the time when all of the five test specimens broke was determined as the cold-resistance temperature. The cold-resistance temperature of −20° C. or less was evaluated as satisfactory.

Table 1 shows test results.

TABLE 1

| | | Example | | | | | | Comparative example | | |
|---|---|---|---|---|---|---|---|---|---|---|
| | | 1 | 2 | 3 | 4 | 5 | 6 | 1 | 2 | 3 |
| Innermost layer | Polypropylene | 100 | 100 | — | — | — | 100 | 100 | — | 100 |
| | Polyethylene | — | — | 100 | 100 | 100 | — | — | 100 | — |
| | Magnesium hydroxide | — | — | — | — | 10 | — | — | 90 | 50 |
| Outermost layer | Polypropylene | 100 | 100 | 100 | 100 | 100 | 100 | — | — | — |
| | Polyethylene | — | — | — | — | — | — | — | — | — |
| | Magnesium hydroxide | 30 | 50 | 100 | 90 | 90 | 100 | — | — | — |
| Number of insulator layer | | 2 | 2 | 2 | 2 | 2 | 3 | 1 | 1 | 1 |
| Thickness of layer | Innermost layer (μm) | 25 | 50 | 75 | 100 | 100 | 25 | 200 | 200 | 200 |
| | Outermost layer (μm) | 175 | 150 | 125 | 100 | 100 | 100 | — | — | — |
| Assessment | Flame retardancy | passed | passed | passed | passed | passed | passed | failed | passed | passed |
| | Wear resistance | passed | passed | passed | passed | passed | passed | passed | failed | failed |
| | Cold resistance (° C.) | −25 | −30 | −25 | −30 | −25 | −30 | −25 | −25 | −15 |

According to Table 1, it was shown that the insulated wires according to the comparative examples all have failures in either of flame retardancy or wear resistance.

To be more specific, in the insulated wire according to Comparative Example 1, the insulator is made up only of one innermost layer which is in contact with the conductor and the innermost layer contains no flame retardant, and therefore, the insulator has a failure in flame retardancy. In each of the insulated wires according to Comparative Examples 2 and 3, the insulator is made up only of one innermost layer which is in contact with the conductor and the innermost layer containing a large amount of a flame retardant, which causes unfavorable adherence between the insulator and the conductor, and therefore, the insulated wires according to Comparative Examples 2 and 3 each have a failure in wear resistance. Additionally, the insulated wire according to Comparative Example 3 has a failure in cold resistance compared with the insulated wires according to the present examples.

Meanwhile, in each of the insulated wires according to the present examples, the conductor is covered with the insulator of two or three layers in which the outermost layer of the insulator is made from the resin composition containing a large amount of the flame retardant, while the innermost layer of the insulator is made from the resin composition containing no flame retardant or a smaller amount of the flame retardant than in the outermost layer. Therefore, it is found that the insulated wires according to the present examples are excellent in flame retardancy and wear resistance. At the same time, it is found that the insulated wires according to the present examples are excellent also in cold resistance. Accordingly, it is conceivable that, in the insulated wires according to the present examples, the conductors and the insulators have sufficient adherence therebetween.

While the preferred embodiments of the present invention have been described above, it is to be understood that variations and modifications will be apparent to those skilled in the art without departing the scope and spirit of the present invention.

1. An insulated wire comprising:
a conductor; and
an insulator made up of multiple layers, which covers the conductor, wherein the outermost layer of the insulator is made from a resin composition containing a flame retardant, and
the innermost layer of the insulator is made from a resin composition which contains a smaller amount of a flame retardant than in the resin composition of the outermost layer, or contains no flame retardant.

2. The insulated wire according to claim 1, wherein the outermost layer contains 30 to 250 parts by mass of the flame retardant with respect to 100 parts by mass of a resin ingredient in the outermost layer.

3. The insulated wire according to claim 1, wherein the innermost layer contains 5 to 50 parts by mass of the flame retardant with respect to 100 parts by mass of a resin ingredient in the innermost layer.

4. The insulated wire according to claim 1, wherein the innermost layer has a thickness ½ or less than that of the insulator.

5. The insulated wire according to claim 1, wherein the insulator has a thickness of 0.5 mm or less.

6. A wiring harness comprising the insulated wire according to claim 1.
